(19) United States
(12) Patent Application Publication
(10) Pub. No.: US 2005/0246271 A1
(43) Pub. Date: Nov. 3, 2005

(54) Method of preserving rights in land

(76) Inventor: John S. Erwin, Water Mill, NY (US)

Correspondence Address: Muserlian, Lucas and Mercanti LLP, 475 Park Avenue South, New York, NY, 10016, US

(21) Appl. No.: 10/837,073

(22) Filed: Apr. 30, 2004

(51) Int. Cl. G06F 17/60

(52) U.S. Cl. 705/39

(57) ABSTRACT

This invention relates to a method of preserving rights, such as development rights, in land owned by a landowner. The invention uses financed life insurance, a bargain sale and the use of a trust or other entity, whereby a life insurance policy on the life of the landowner or rights owner is owned by the trust, and the trust borrows money from a lender to pay premiums on the life insurance policy.

### BACKGROUND OF THE INVENTION

In many locations a municipality or other entity often wishes to preserve rights in land, such as open space, historic landmarks, mineral rights or other rights for the benefit of the beauty and character of the locale. This can include farming communities, beach communities, woodland areas or even communities with even only a small unique open space. Development is often not in the best interest of the local municipality or the local citizens who may wish to slow or halt the development to preserve open land or other rights for environmental, farming, scenic views or other reasons.

Real estate developers often seek to take advantage of the vulnerability of open spaces, particularly upon the death of a landowner, and open spaces are often lost to developers despite the interest of the municipality and the landowner to preserve the land as open space due to the municipality's lack of sufficient available funds to purchase and retire development rights, either during the landowner's life or at death.

Municipalities and landowners have recognized that the purchase and retirement of development rights can serve the purposes of preserving open spaces and give the landowner the economic value of his property while reducing the land's value for estate tax purposes. Landowners have historically been concerned about property in their estate being valued at the highest and best use, not actual use such as farming. This often results in the need to sell the land to generate the funds to pay the estate taxes, a situation a landowner wishes to avoid.

In the past, the usual method for the purchase of development rights is for the landowner and the municipality to enter into an agreement whereby the landowner sells the development rights to the municipality for the full value paid in one payment. A problem with this procedure for the municipality is that it must have immediately available funds sufficient to pay the full purchase price. Often, the municipality does not have such funds to make such a one-time purchase. A problem for the landowner is that the full sales price is subject to both income and estate taxes.

Thus, a need exists for a method for arranging and financing the sale of development rights to a municipality to accomplish two objects —preserving open space by retiring the development rights, and minimizing the landowner's income and estate taxes.

### SUMMARY OF THE INVENTION

The present invention concerns both the preservation of rights in land and the minimizing of taxes for a landowner.

The invention serves both of the interests of a municipality to preserve open spaces, and the interests of a landowner to realize the economic value of the land, reduce the value of the land for estate tax purposes, and pass the land and money equal to the full value of the development rights or other rights to family or heirs. The invention manages the arrangement of a sale of real estate development rights to a municipality or other entity at a substantial discount while still giving the landowner and his or her heirs the full value of the rights in both an income and estate tax efficient way.

To accomplish these objectives, the invention relates to a method of using financed life insurance to facilitate the financing of a bargain sale installment purchase of property rights, for example the purchase of development rights by a town or other municipality or other government entity (hereinafter “Town”) or a Land Trust, charity, private individual, company, foundation or other entity as part of a plan to preserve open space or other characteristics of the land.

More specifically, in one embodiment, the invention comprises a method of preserving rights in land owned by a landowner, comprising:

(a) selling rights in the land to a buyer;

(b) retiring the rights by the buyer;

(c) buying a life insurance policy on the life of the landowner in the name of an entity other than the landowner, the policy having a death benefit payable to the entity;

(d) gifting the entity with proceeds from the sale of the rights;

(e) borrowing money by the entity in an amount sufficient to cover payment of premiums for the life insurance policy; and

(f) paying the death benefit to the entity upon death of the landowner, the entity then paying back the borrowed money.

In another embodiment, the invention comprises a method of preserving open space on land owned by a landowner, the method performed at least in part within a computer and comprising:

(a) selling development rights on the land in a bargain sale to a buyer in exchange for a negotiated initial payment plus installment payments sufficient to cover the cost of interest on a loan from a lender to finance a life insurance policy on the life of the landowner plus any income tax payable by the landowner;

(b) retiring the development rights by the buyer;

(c) creating an irrevocable trust;

(d) buying a life insurance policy from an insurance company on the life of the landowner, the policy being owned by the trust and having a death benefit payable to the trust, in exchange for payment of premiums to the insurance company for the policy;

(e) periodically gifting the trust by the landowner with proceeds from the bargain sale;

(f) obtaining a loan to the trust from a lender in an amount sufficient to cover payment of the premiums, in exchange for payments to the lender by the trust of interest on the loan; and

(g) paying the death benefit by the insurance company to the trust upon death of the landowner, the trust then paying off the loan to the lender and paying the balance of the death benefit as directed by the trust.

### BRIEF DESCRIPTION OF THE DRAWINGS

These and other features and advantages of the invention will now be described with reference to the drawings of certain preferred embodiments, which are intended to illustrate and not to limit the invention, and in which like reference numbers represent corresponding parts throughout, and in which:

FIG. 1 is a block and flow diagram showing an embodiment of steps of the present invention occurring during a landowner's life; and

FIG. 2 is a block and flow diagram showing an embodiment of steps of the present invention occurring after the landowner's death.

### DETAILED DESCRIPTION OF THE INVENTION

Definitions

For purposes of this application, and in order to more fully appreciate the scope and nature of the invention, the following terms are defined:

“Landowner” means an owner of land or of any rights in land, such as development rights, mineral rights, water rights, air rights or any other rights, or any owner of land having a historic structure or landmark thereon or otherwise having a character whose preservation has value.

“Town” means any entity that wishes to purchase land or rights from a landowner.

“Trust” means any entity that owns a life insurance policy on a landowner's life.

“Lender” means any entity providing a loan to the owner of an insurance policy on the landowner's life sufficient to allow the policy owner to pay annual insurance premiums.

“Insurance Company” means any provider of life insurance on a landowner's life.

Example of Preserving Open Space

The present invention is useful in the following typical scenario, which is only one of many possible scenarios:

A landowner owns a tract of undeveloped or “raw” land. The development rights in the land have significant value. The landowner does not wish to develop the land at this time, but wishes to sell the development rights to realize some of the land's value, and reduce the land's value in the landowner's estate, while keeping title to the land and keeping the development rights “retired.”

A municipality, Town or other buyer wishes to buy the development rights, in order to retire the development rights and thus keep the land open. The Town also wants to reduce its cash outlay on the purchase to maximize the buying power of the money it has available for the purchase of development rights by not being required to pay the full value of the rights.

If the landowner sells the development or other rights, he or she most likely will realize a capital gain and be liable for the payment of income tax at the time of sale and estate tax to the Federal and State governments at the time of death. The landowner and his or her heirs wish to minimize income and estate taxes and maximize their after tax return in the most secure manner possible.

The issue then is, how can the transaction be financed and arranged to the satisfaction of both the landowner, the heirs and the Town or other buyer, at the least cost to the Town and the greatest return to the landowner by minimizing taxes? The present invention accomplishes these goals.

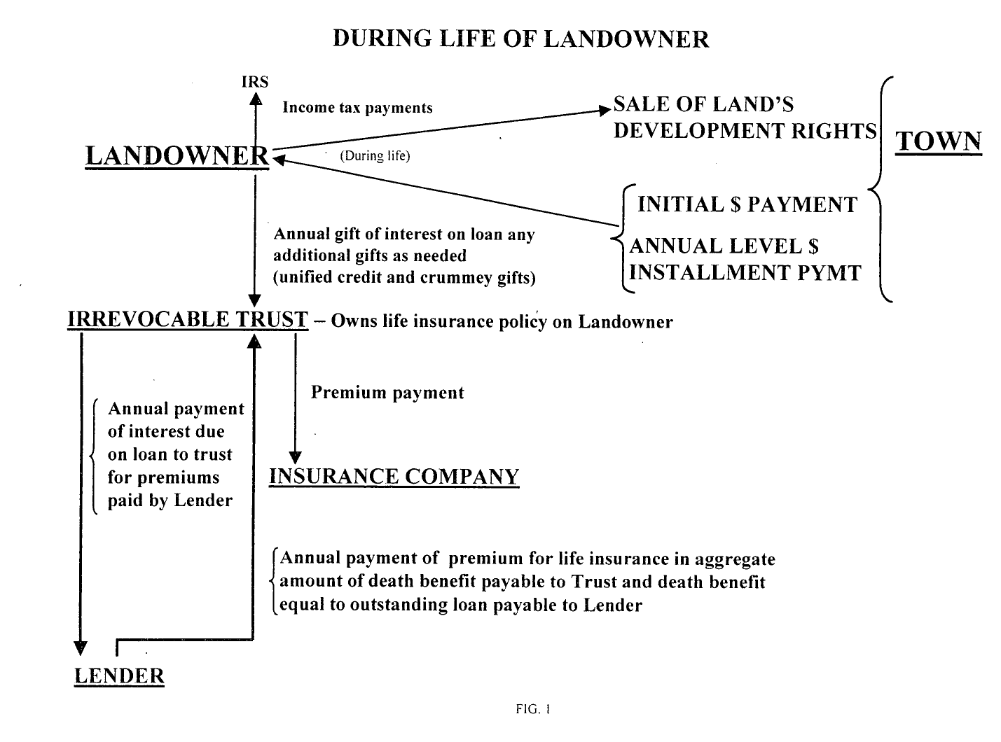

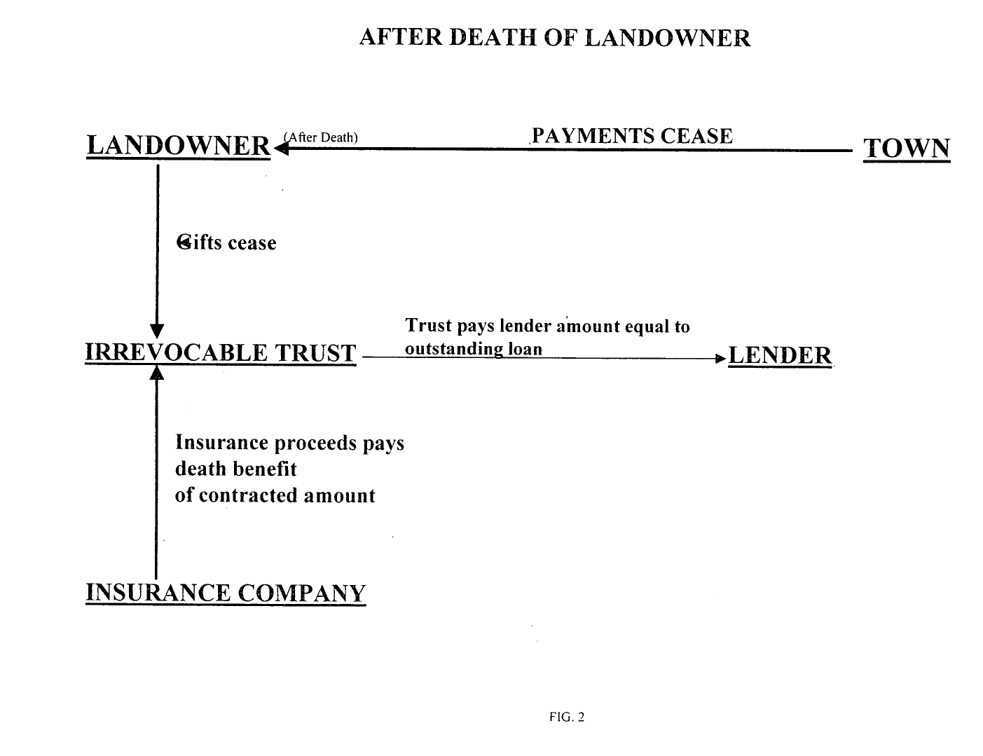

The drawings of the invention represent one embodiment of the method of the invention involving a sale of development rights to a Town. There are two stages. The first stage, in FIG. 1, represents actions taken during the life of the landowner. The second stage, in FIG. 2, represents actions taken after the life of the landowner.

Turning now to the drawings, FIG. 1 is a block and flow diagram showing some steps of one embodiment of the present invention, occurring during a landowner's life. An example may be instructive for illustration purposes. First, assume that a landowner owns real estate, specifically raw land, either individually or jointly with a spouse. The land has certain rights associated with it, including development rights. Those rights have significant value. In some communities, the development rights are worth many millions of dollars.

Continuing with this example, some commercial developers wish to acquire the development rights. But the landowner does not wish to develop the land at this time. And others in the community, such as the Town within which the property is located, also do not wish the land to be developed.

But the landowner does not want to just sit on the property forever or be forced to sell the property, or rights in the property, to pay estate taxes. He or she wishes to realize some value from the property. So, the landowner negotiates the sale of the development rights to the Town. A bargain sale is negotiated and closed. The Town purchases the development rights at a discount, i.e., less than the fair market value in an installment sale whereby the Town makes a cash down payment to the landowner, and periodic level payments thereafter for the life of the landowner and spouse, if any. The landowner retains title to the property.

During the negotiation period with the Town, the landowner determines that he or his or her spouse is insurable and if so, creates an irrevocable trust to own and be the beneficiary of a life insurance policy on the life of the landowner. Typically, the landowner's children are the beneficiaries of the trust.

At the same time that the development rights are sold, the trust buys a “financed life insurance” policy having a death benefit from an insurance company on the life of the landowner (or on the second-to-die, if the landowner is married).

The trust also obtains a loan from a lender (the insurance company, a bank or some other lender). The lender makes a loan periodically to the trust equal to the amount of life insurance premiums payable to the insurance company. The loan is to pay for premiums on the life insurance policy.

The trust pays the premiums to the insurance company as required, and pays interest on the loan to the lender as required.

The Town retires the development rights, which eliminates the possibility of development, thus preserving open space.

The landowner is responsible for paying his or her own capital gains taxes on the initial down payment and installment payments to the Federal Internal Revenue Service (IRS) and to state government, if required. Since the sale to the Town is a bargain sale, which amounts to a partial gift to the Town, the landowner may take such charitable tax deduction for Federal income tax purposes equal to the difference between the fair market value of the rights and the down payment amount, plus the present value of the installment payments, subject to applicable limitations.

Each year, the landowner (not the trust) receives an annual installment payment from the Town for the development rights. The landowner uses the annual payment to pay the landowner's income tax due on the installment payments and to make annual gifts to the trust at least equal to the number of trust “Crummey” beneficiaries to use toward payment of the interest due on the loan.

The landowner may also transfer an amount equal to his and/or her “unified credit equivalent” available for lifetime gifts into the trust to use toward the payment of the interest due on the loan.

Any unused portion of the annual payment not currently gifted to the trust will be held to use towards future interest payments.

Looking now at FIG. 2, upon the death of the landowner (or both the landowner and spouse, if married, and the policy is on the last to die), gifts to the trust cease, and payments from the Town cease. The life insurance company pays the contracted death benefit (life insurance proceeds) to the trust. The trust then pays off the outstanding balance on the loan to the lender.

Normally, the trust will not have to pay income tax or estate tax on the life insurance proceeds. Since the proceeds do not go into the estate of the landowner, the landowner's estate tax burden is reduced. The trust may be structured to also reduce estate taxes in the landlord's heirs' estate.

After death, the trust could either terminate or continue for the life of the children as was desired by the landowner and landowner's heirs at the time the trust was established.

In a feature of the invention, monetary amounts and other data at all points of the transaction are entered into and stored in a programmed computer. The data entered include the amount of the death benefit agreed to be paid to the irrevocable trust established by the landowner, and the ages of the insured(s) to determine the annual premium needed to sustain a policy equally to both the amount of the specified death benefit to the landowner's trust and the amount of the loans from the lender to the trust to enable the trust to pay the insurance premiums, and the amount of the annual interest due from the landowner for the loan for premium payment is then calculated based on the inputted data. The interest amount and other relevant data is inputted into the computer to enable it to compute the amount of the level annual installment payment required to be paid by the Town to the landowner to provide the landowner with the amount necessary to pay the loan interest and the income taxes due by reason of the receipt of the installment payment.

The program also tracks the amounts due from the Town to the landowner to be certain that all the proper payments are being made. The program also provides the landowner with a schedule of the annual interest payments required to be gifted to the trust and the amount of the annual payment from the town, which is subject to income tax to enable the landowner to properly file his or her income tax returns.

Another feature of the invention is that, since transactions are automated using a computer, rights transactions from more than one landowner can be tracked, monitored, recorded and reported simultaneously.

Further Example

The following is a further example of how one embodiment of the present invention operates in a scenario where open real estate space is to be preserved:

A landowner owns land with development rights worth 20 million dollars.

A town wants to buy the development rights.

The town and the landowner negotiate a bargain sale for the development rights.

The town agrees to pay X million dollars down and Y dollars a year to the landowner for the landowner's life.

The landowner creates an irrevocable trust to purchase a financed life insurance policy of at least 20 million dollars on the life of the landowner, or a financed policy on the second-to-die, whether it may be the landowner or his or her spouse.

The town pays an annual level amount to the landowner to cover all of the loan interest of the financed life insurance, and the income tax on the portion of the installment sale that is considered taxable.

Results

The Town gets the development rights at a substantial discount. The development rights are retired, and the land is protected from development.

The landowner keeps the land and rights. The landowner receives some money currently, and the trust receives at least 20 million dollars on death of the landowner (or on the second to die)

The landowner's family is financially better off than if the development rights were sold to a developer or to a town either today or upon second death. The landowner's family gets at least 20 million dollars from the trust, income and estate tax free. The landowner's family also gets the remainder of the initial proceeds from the Town from the sale of the development rights.

Risks to Landowner and Solutions

The present invention considers and minimizes several risks. For example:

Landowner or spouse not insurable.

Do not proceed with transaction until insurance is available.

Interest rates rise.

Landowner has significant cash available to cover this cost, or locks in a fixed rate loan.

Insurance company does not renew loan.

Landowner locks in terms of the loan, or a private lender is found.

Town defaults on installment sale payments.

Establish a sinking fund to generate source of funds. However, this would make installment sale proceeds taxable in the year the sinking fund was created.

Landowner over-spends from the initial payment, leaving no collateral.

Isolate enough of the initial payment to remove the risk. Also, the life insurance policy cash value can become collateral.

While the invention has been described herein with reference to certain preferred embodiments, these embodiments have been presented by way of example only, and not to limit the scope of the invention.

1. A method of preserving rights in land owned by a landowner, comprising:
(a) selling rights in the land to a buyer;
(b) retiring the rights by the buyer;
(c) buying a life insurance policy on the life of the landowner in the name of an entity other than the landowner, the policy having a death benefit payable to the entity;
(d) gifting the entity with proceeds from the sale of the rights;
(e) borrowing money by the entity in an amount sufficient to cover payment of premiums for the life insurance policy; and
(f) paying the death benefit to the entity upon death of the landowner, the entity then paying back the borrowed money.

2. The method of claim 1, in which the rights are development rights.

3. The method of claim 1, in which the entity is an irrevocable trust.

4. A method of preserving open space on land owned by a landowner, the method performed at least in part within a computer and comprising:
(a) selling development rights on the land in a bargain sale to a buyer in exchange for a negotiated initial payment plus installment payments sufficient to cover the cost of interest on a loan from a lender to finance a life insurance policy on the life of the landowner plus any income tax payable by the landowner;
(b) retiring the development rights by the buyer;
(c) creating an irrevocable trust;
(d) buying a life insurance policy from an insurance company on the life of the landowner, the policy being owned by the trust and having a death benefit payable to the trust, in exchange for payment of premiums to the insurance company for the policy;
(e) periodically gifting the trust by the landowner with proceeds from the bargain sale;
(f) obtaining a loan to the trust from a lender in an amount sufficient to cover payment of the premiums, in exchange for payments to the lender by the trust of interest on the loan; and
(g) paying the death benefit by the insurance company to the trust upon death of the landowner, the trust then paying off the loan to the lender and paying the balance of the death benefit as directed by the trust.
